(19) United States
(12) Patent Application Publication
(10) Pub. No.: US 2003/0171039 A1
(43) Pub. Date: Sep. 11, 2003

(54) Electrical box for providing electrical power and low voltage signals to a building

(76) Inventor: Forrest L. Pierson JR., Dallas, TX (US)

Correspondence Address: WORLDCOM, INC., TECHNOLOGY LAW DEPARTMENT, 1133 19TH STREET NW, WASHINGTON, DC, 20036, US

(21) Appl. No.: 10/087,983

(22) Filed: Mar. 5, 2002

(51) Int. Cl. H01R 9/22

(52) U.S. Cl. 439/709

(57) ABSTRACT

An electrical box is provided for receiving an electrical unit. A low voltage section is configured to provide a low voltage connection, wherein a barrier isolates the low voltage connection. A high voltage section is separated from the low voltage section via the barrier to provide a high voltage connection. The high voltage section includes a plurality of bus bars, and a plurality of displacement connectors that are coupled to the plurality of bus bars and are configured redundantly to accept wires.

### RELATED APPLICATION

This application is related to U.S. patent application Ser. No. 09/695,097 (Attorney Docket RIC-00-035), filed Oct. 24, 2000, entitled “AN ELECTRICAL UNIT FOR MATING WITH AN ELECTRICAL BOX (As Amended),” and to U.S. patent application Ser. No. 09/695,124 (Attorney Docket RIC-00-029), filed Oct. 24, 2000, entitled “METHOD AND SYSTEM OF AN INSTALLER-FRIENDLY, MODULARLY ADAPTABLE, ELECTRICAL, OUTLET GANG BOX”; their entireties of which are incorporated herein by reference.

### FIELD OF THE INVENTION

The present invention relates generally to an electrical box, and more particularly relates to a multi-compartment electrical box.

### BACKGROUND OF THE INVENTION

In providing electrical power to commercial and residential buildings, a main power line typically carrying 100-200 Amps of 220V AC single phase power enters a building from an electric company power grid and is connected to a service box that distributes power to the entire building. In the service box, the 220V AC power is center tapped with a neutral return to provide two 110V AC sources of opposite polarity and ground terminal connected to the earth. Because of the high voltage sources within the service box, low voltage sources cannot be brought into the box without violating the National Electrical Code (NEC).

In the service box, power from the main power line is divided into branch circuits each of which typically provides 110V AC power circuit breakered at 15 to 25 Amps to several plugs, switches, and/or other electrical units located in different areas of the building. In providing such branch circuits, multi-conductor electrical cable must be routed from a branch circuit breaker in the main service box to electrical boxes that contain each of the electrical units in the branch circuit. The multi-conductor cable used to route the branch circuits typically includes a white insulation neutral wire, a black insulation hot wire, and a bare or green insulation ground wire to carry 110V AC throughout the building. In branch circuits, in which 220V AC are used, a red insulation alternative hot wire is also provided in the multi-conductor cable, and higher currents are allowed for certain high power appliances, such as stoves, ovens, air conditioners, heaters and clothes dryers.

Current practice in wiring a branch circuit is to route individual segments of the multi-conductor electrical cable from the interior of one electrical box to the interior of a subsequent electrical box in the circuit. When all electrical boxes are connected with cable segments, the free ends of the cable segments at the interior of each box are connected to complete the branch circuit. In completing the branch circuit, the outer insulation sheathing is first stripped off of each free end of cable to expose the internal electrical wires, and the insulation is then stripped off of the end of each wire to expose the copper conductor of the wire. The bare conductors of each wire are then connected by use of twist-on connectors or by connecting the conductor to a switch, plug, or other electrical unit in the box and the cables are folded within the interior of the box to make room for the electrical unit.

Similarly, when a new load, such as an electrical outlet is added to an existing electrical circuit, wires of the existing circuit must be spliced into and reconnected by use of the added load. Specifically, in adding a load, the electrician must first cut an opening in the finished wall to reveal the existing electrical cable, which is then cut to provide two ends of the cable which are inserted into an electrical box used for housing the electrical outlet to be added. In situations whereby the electrical cable is not long enough that the ends of the cable can reach the interior of the new electrical box, it may be necessary for the electrician to install at least one junction box to extend the ends of the cable. The ends of the cable are then prepared and the internal wires are stripped as described above. The wire ends are reconnected through the electrical unit in the box to complete the circuit, and the wires are folded into the new box as discussed.

These conventional methods of wiring a building, however, present a number of problems to the electrician and homeowner. First, from the standpoint of the electrician, the effort it takes to cut and route cable segments between electrical boxes, and then to strip and reconnect the internal wires of the cable using the above-described method is very time consuming and labor intensive. In addition, in installing a new electrical outlet, existing wires may have to be extended by use of a junction box, thereby requiring extra time. In addition, because multi-conductor electrical cables have three or four individually insulated conductors bound together by an outer sheathing, the cable is stiff and difficult to fold into the electrical box in such a way that plugs, switches, and other electrical units will have enough room to fit in the box. This creates greater inefficiency and makes it difficult for the electrician to sufficiently align all of the plugs and/or switches in a multi-ganged box so that a cover plate can be placed over the electrical unit and box.

In addition to the above-described efficiency problems, a significant amount of wire is wasted in routing all branch circuits from one main service box to each branch circuit region that the service box is to power. For example, providing power to the top floor of a large home may require two 15 Amp branch circuits in which case two multi-conductor electrical cables need to be routed from the main service box located in the basement, for example, to the area powered by each circuit. Distributed service panels that may resolve this problem have not been feasible in such situations due to their expense and large size that is not desirable for living space. Although to a lesser extent, electrical wire is also wasted when cable ends must be extended to reach the interior of a new electrical box when adding a load to an existing circuit.

From the home or building owner's standpoint, with the hundreds of electrical connections inside even a small house, the complicated method of cutting and stripping cables and internal wires as described above is likely to result in at least one poor connection that will eventually fail. The possibility of a poor connection is also present for the addition of new outlets. The failure of such a poor connection can be as benign as denying electrical service to all downstream electrical boxes in the circuit or as disastrous as causing a house to burn down. Moreover, nicking, or cutting into, of a conductor of each wire may occur each time insulation is cut off the wire to expose bare copper for the connection. This reduces the wire surface area available for carrying electrical current and can cause localized overheating, with the potential to start a fire. Reduced surface area may also cause a significant voltage drop that slows down motors, dims lights, or affects the operation of voltage sensitive appliances.

Finally, because the multi-conductor electrical cable enters each electrical box and must be folded within the box, space inside each electrical box is limited thereby limiting the number and sophistication of features offered by the electrical units used with the electrical box.

Based on the foregoing, there is a clear need for an electrical box that provides safe and reliable power to a home and/or commercial building, while accommodating low voltage sources.

There is also a need for an electrical box that allows electrical wires to be connected to an exterior surface of the electrical box without occupying space within the electrical box.

There is further a need for an electrical box that allows electrical wires to be connected to the electrical box with minimal cutting and stripping of insulation from the electrical wires.

Finally, there is a need for an electrical box that accepts large electrical units having sophisticated functions and allows easy alignment of electrical units within the electrical box.

### SUMMARY OF THE INVENTION

The present invention addresses the above stated needs by providing a junction box that electrically isolates low voltage connections from high voltage connections.

According to one aspect of the invention, an electrical box is provided for receiving an electrical unit. A low voltage section is configured to provide a low voltage connection. A barrier isolates the low voltage connection. A high voltage section is separated from the low voltage section via the barrier to provide a high voltage connection. The high voltage section includes a plurality of bus bars, and a plurality of displacement connectors that are coupled to the plurality of bus bars and are configured redundantly to accept wires. Under this arrangement, electrical wires are advantageously connected to an exterior surface of the electrical box without occupying space within the electrical box

According to another embodiment of the present invention, an apparatus is provided for receiving an electrical unit. A housing has a first compartment that is configured to provide a low voltage connection and a second compartment that is configured to provide a high voltage connection. The first compartment and the second compartment are electrically isolated. The second compartment includes a plurality of bus bars, and a plurality of displacement connectors that are coupled to the plurality of bus bars and are configured redundantly to accept wires. A cover plate is attached to a backside of the housing to hold wires into the plurality of displacement connectors. This approach advantageously permits collocation of low voltage connections and high voltage connections with a single electrical box.

In another embodiment of the present invention, an electrical box is provided for receiving an electrical unit. The electrical box includes means for housing a low voltage connection, means for isolating the low voltage connection, and means for housing a high voltage connection that is separated from the means for housing the low voltage connection via the isolation means. Additionally, the electrical box includes means for electrically connecting wires within the means for housing the high voltage connection. Such an arrangement advantageously enhances ease of installation of the electrical box.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of an electrical unit mating with an electrical box in accordance with an embodiment of the present invention;

FIG. 2 is a side view of an electrical unit partially mated with an electrical box in accordance with an embodiment of the present invention;

FIGS. 3A and 3B are a front face view and an end view respectively of an electrical unit in accordance with an embodiment of the present invention;

FIGS. 4A and 4B are a side view and an end view respectively of an electrical box in accordance with an embodiment of the present invention;

FIG. 5 is a back view of an electrical box in accordance with an embodiment of the present invention;

FIGS. 6A and 6B are front views of an electrical box in accordance with an embodiment of the present invention; and

FIG. 7 is an interior view of an electrical box cover plate in accordance with an embodiment of the present invention.

### DESCRIPTION OF THE PREFERRED EMBODIMENTS

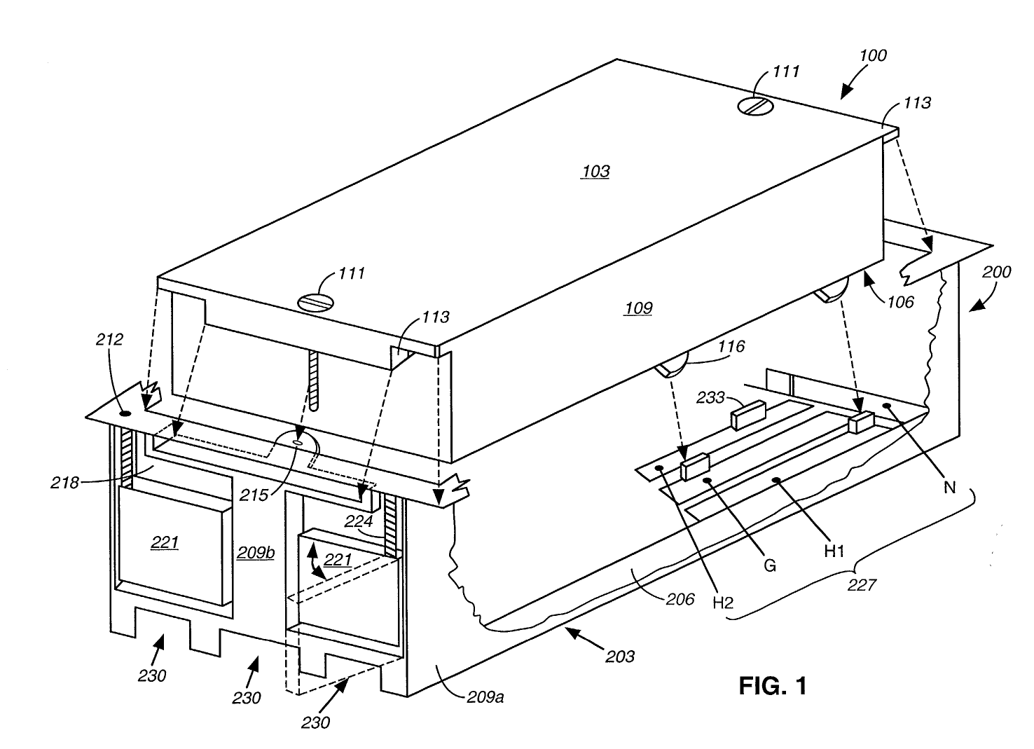

Referring now to the drawings, wherein like reference numerals designate identical or corresponding parts throughout the drawings, an electrical unit and electrical box for providing efficient and reliable wiring of a building, is shown. An embodiment of this invention is shown in FIG. 1, which is a perspective view of an electrical unit 100 mating with an electrical box 200 according to the present invention.

The electrical unit 100 includes a front face 103 and an opposing mating surface 106 joined by a unit sidewall 109. The front face 103 receives two mating screws 111 each of which penetrate a mating edge 113 that protrudes from the unit sidewall 109 in a direction parallel to the front face 103 of the electrical unit 100. Mounted on the mating surface 106 of the electrical unit 100 is a plurality of sockets 116 made of an electrically conductive material. The electrical unit 100 is preferably constructed of a rigid plastic or any suitable electrically insulating material.

The electrical box 200 includes a main body 203 that is divided by a barrier (not shown) into two sections: a low voltage section and a high voltage section. The low voltage section can be partitioned into one or more compartments to provide for peripheral devices that can be plugged into the junction box 200. The high voltage section has a conductor carrying surface (i.e., carrier) 206 and box sidewalls 209a and endwalls 209b that protrude at right angles from the conductor carrying surface 206 to define an open ended cavity for receiving electrical unit 100. A seating lip 212 protrudes substantially perpendicularly from the box sidewalls 209a and endwalls 209b around a perimeter of the opening of the electrical box 200 and provides a mating surface for the mating edge 113 of the electrical unit 100. Likewise, tabs (only one shown) including a screw hole 215 are mounted to an interior surface of each endwall 209b in a position of the endwall suitable for receiving the mating screw 111 of the electrical unit 100.

Box endwalls 209b of the electrical box 200 include recessed paddle openings 218 positioned adjacent to fastening paddles 221 rotatably mounted to an interior surface of the box sidewall 209b via a shaft 224. As seen by the phantom paddle in FIG. 1, the fastening paddles 221 may be rotated to protrude from box endwall openings 218 to fasten the electrical box 200 to a finished wall, as further described below. While only one endwall 209b is shown to include the recessed paddle openings 218 and paddles 221, it is to be understood that that this fastening structure will is be included on the opposing endwall 209b as well. Moreover, the fastening structure may be provided a sidewall 209a in addition to or in lieu of endwall 209b.

Mounted on an interior surface of the conductor carrier 206 are a plurality of interior bus bars 262. Each bus bar 227 is electrically connected to one of a neutral, hot, ground, or alternative hot electrical wire of a multi-conductor electrical cable carrying building power, by connectors mounted on an exterior surface of the conductor carrier 206 as will be described. The multi-conductor cable is routed to the electrical box 200 by way of cable channels 230 provided on an underside of the electrical box 200. As seen in FIG. 1, the interior neutral bus bars, hot bus bars, ground bus bars, and alternative bus bars are represented by the reference designations N, H1, G, and H2, respectively. Moreover, these reference designations are used to represent the conductivity type of various components of the invention throughout the several drawings. Mounted on each bus bar 227 is a conductive member 233 in electrical contact with the bus bar 227 to which it is mounted. Conductive members 233 are positioned in a suitable configuration to receive the conductive sockets 116 of the electrical unit 100 when the electrical unit 100 is fully mated with the electrical box 200. The dashed arrows of FIG. 1 indicate mating surfaces of the electrical unit 100 and electrical box 200 in FIG. 1.

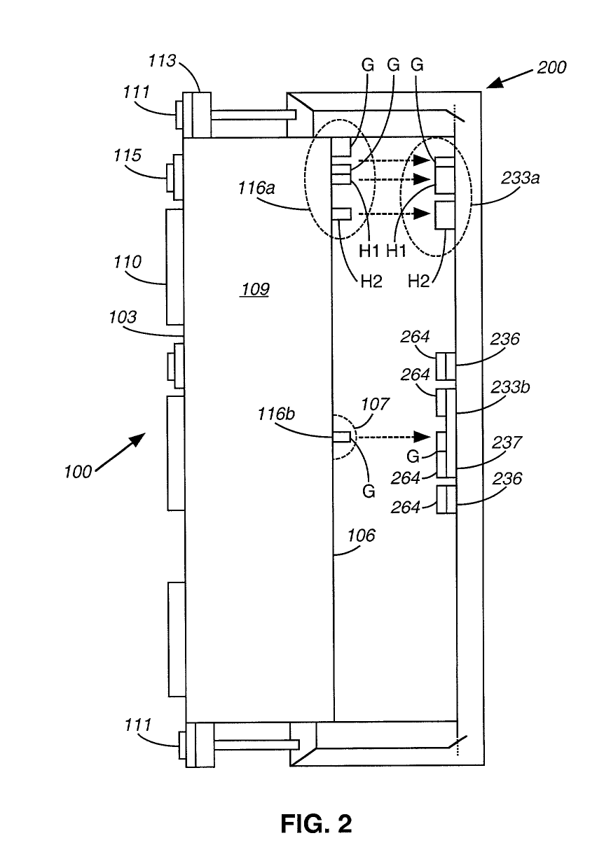

FIG. 2 shows a side view of an electrical unit 100 mating with an electrical box 200 according to the present invention. A portion of the box sidewall 209 of the electrical box is removed to reveal interior connections between the electrical unit 100 and electrical box 200. Also shown are mating screws 110 penetrating the mating edge 113 of the electrical unit 100 and inserted into the electrical box 200 as discussed with respect to FIG. 1.

The electrical unit 100 shown in FIG. 2 is a circuit breakered six plug module; however, it is to be understood that many types of electrical units may be used in accordance with the present invention as will be described. Mounted on the front face 103 of the electrical unit 100 are electrical outlets 110 and push button circuit breaker switches 115, each of which corresponds to a respective electrical outlet 110. Conductive sockets 116 on the mating surface 106 are grouped in groups 116a, and 116b to indicate a vertical positioning of the conductive sockets 116. Similarly, the conductive members 233 mounted on the interior bus bars 262 (not shown in FIG. 2) are grouped in groups 233a, and 233b to show a vertical positioning of the conductive members 233 within the electrical box 200. The conductivity type of each conductive socket 116 and each conductive member 233 is indicated by the reference designations N, H1, G, and H2 as previously discussed.

According to the present invention, building power is present on the conductive members of 233 of the electrical box 200 via connections (not shown in FIG. 2) on the backside of the electrical box and is transferred to the electrical unit 100 by way of the conductive sockets 116 which make electrical contact with the conductive members 233 when the electrical unit 100 is mated with the electrical box 200. Accordingly, as shown in FIG. 2, the conductive sockets 116 are configured on the mating surface 106 such that each of the conductive sockets 116 mates with a same conductivity type conductive member 233 each of which is also suitably configured on the interior surface of the conductor carrier 206. The dashed arrows of FIG. 2 indicate the approximate mating contact of the conductive sockets 116 with the conductive members 233 when the electrical unit 100 is mated with the electrical box 200.

The electrical unit 100 may include a non-conductive block 107 shown in phantom as a safety feature, which prevents a non-compatible electrical unit from mating with a particular electrical box 200. For example, if electrical box 200 is configured to be a high current box, as will be described below, then electrical units 100 not rated for high current preferably would include non-conductive blocks 107 positioned such that they obstruct the mating of the electrical unit 100 with the electrical box 200. It is to be understood that the non-conductive blocks 107 are exemplary only in FIG. 2 as the electrical unit 100 of FIG. 2 is compatible with a high current box due to the circuit breaker switches 115. An end view of conductive horizontal tabs 236 and a side view of conductive vertical tab 237 are also shown in FIG. 2. The conductive tabs 236 and 237 are removably fastened to the bus bars 262 of the conductor carrier 206 by, for example, #4 or #6 flat head screws 264. It should be noted that any number of configurations for electrical box 200 can be deployed, depending on the particular configuration of the electrical unit 100.

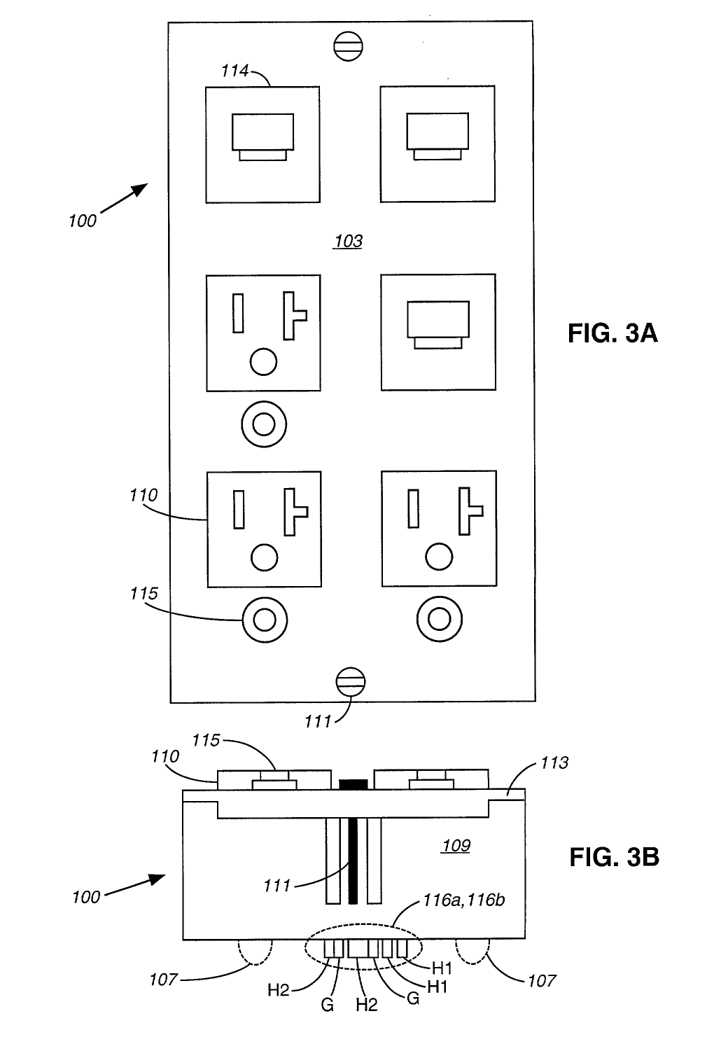

FIGS. 3A and 3B depict a front face view and a bottom end view respectively of the electrical unit 100 of FIG. 2. As seen in FIG. 3A, three electrical outlets 110 are positioned on the lower area of the front face 103 of the electrical unit 100. Each of the electrical outlets 110 is a standard 110V AC 20 amp outlet used in household wiring and each outlet has a corresponding push button breaker switch 115. Each push button breaker switch 115 is designed to pass electrical power to its corresponding electrical outlet when the switch is in a depressed position, and to block power when in an out or tripped position. Further, three jacks 114, according to one embodiment of the present invention, are provided for low voltage connections (e.g., RJ-11 telephone jacks, RJ-45 Ethernet connections, and etc.). It is recognized that any other types of low voltage connections can be utilized to support any number of peripheral devices.

FIG. 3B shows the horizontal positioning of the conductive sockets 116 on the electrical unit 100. The conductive sockets 116 shown in FIG. 3B are conductive sockets included in groups 116a, 116b, and 116c of FIG. 2; however, conductive sockets that would obstruct the non-conductive blocks 107 (or bumps) have been removed so that positioning of the non-conductive bumps 107 can be clearly seen.

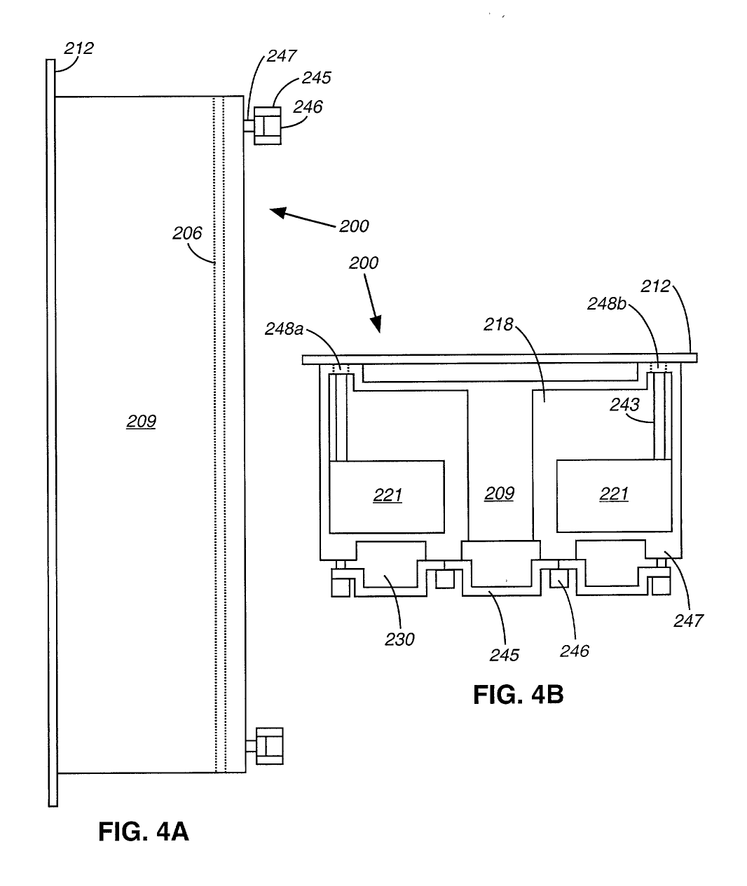

FIGS. 4A and 4B show a side view and an end view of the electrical box 200, respectively. As seen in these figures, conductor carrier 206 is inset from the back surface of the cavity defined by the box sidewalls 209a of the electrical box 200. As best seen in FIG. 4B, the conductor carrier 206 is inset at least enough so that it does not obstruct the cable channels 230. It is to be understood, however, that the inset depth of the conductor carrier 206 and the cable channels 230 may be varied depending on the application of the present invention. For example, in high current applications, the electrical cable used may include wires of a large gauge in which case the cable channels 230 and the conductor carrier 206 are of suitable dimensions for the larger cable. Likewise, it is to be understood that the depth of the cavity of the electrical box 200 may be of any size suitable to receive an electrical unit. The depth of the cavity is preferably slightly less than the width of the framing lumber used to form the wall that the electrical box is to be inserted into so that maximum space is provided for the electrical unit 100.

Cable clamps 245 are provided for clamping electrical cables that enter and exit the electrical box 200. The cable clamps 245 are removably mounted opposing the cable channels 230 by way of cable clamp screws 246. Spacers 247 allow a back cover plate to be installed over the backside of the electrical box 200.

As shown in phantom in FIG. 4B, fastening screws 248 are connected to each shaft 243 for rotating paddles 221 into and out of a fixing position as described with respect to FIG. 1. One fastening screw 248a will turn clockwise to extend the paddle 221 out, then up so the paddle 221 and the seating lip 212 will clamp onto the wall the electrical box 200 is being inserted into. The same screw 248a will turn counter clockwise to release the paddle 221 and swing it back into the recessed area (i.e., opening) 218 so the electrical box 200 can be removed from the wall. The other screw 248b on the same end side will turn counter clockwise to extend it's paddle 221 out and pinch the wall against it and seating lip 212, and turn clockwise to release the wall and swing the paddle 221 back into the recessed area 218. Both screws 248a and 248b are shown, however, for single gang electrical box 200 only one screw with it's associated paddle 221 may be used. In multi-gang boxes 300 (as will be discussed in FIG. 12) one paddle 221 and screw 248 may be adjacent to each corner between endwall 209b and sidewall 209a.

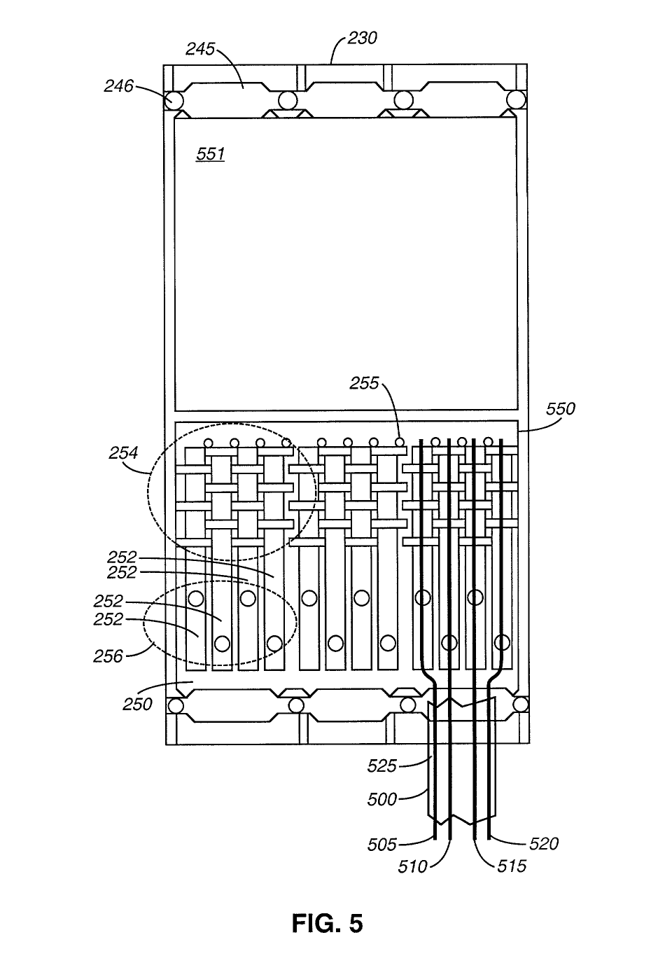

FIG. 5 is a back view of the electrical box 200 having a multi-conductor cable 500 attached thereto. With the electrical box 200, two sections 550 and 551 separate high voltage sources from low voltage sources. The low voltage section 551 allows peripheral devices that are attached to it to bring low voltage electrical connections into the electrical box 200 without violating the NEC. For example, the peripheral devices may include a lamp mount, fire or carbon monoxide detector, glass breakage sensor, low voltage motor controller for blinds, speakers, variable speed fans, dimmable lamps, etc. In an exemplary embodiment, the maximum current supported in the low voltage section 551 is 60 A.

As inserted to the high voltage section 550, the multi-conductor cable 500 includes insulated wires 505, 510, 515, and 520 within an outer insulation sheathing 525 shown as transparent in FIG. 5. Wires 505, 510, 515, and 520 are labeled as black, green, red, and white respectively according to the typical color scheme of multi-conductor electrical cables used in the USA. A back view of cable clamps 245 (also transparent where necessary) and cable clamp screws 246 is also shown. Although the electrical box 200 of FIG. 5 shows three sets of cable clamps 245, it is to be understood that any number of cable clamps 245 may be provided in order to allow a number of cables sufficient to provide power to the electrical box 200 to pass through the electrical box. As shown, a low voltage section 551 utilizes the same type of cable clamps 245 as that of the high voltage section 550; however, it is recognized that the clamps 245 of the low voltage section 551 may differ, depending on the peripheral devices employed. For example, the low voltage section 551 may house connections to sensors, telephone lines, local area network (LAN) connections, etc.

Mounted on conductor carrier 206 are a plurality of conductive exterior bus bars 252 each of which corresponds to one of hot, neutral, ground, and alternative hot conductivity as labeled by “H1”, “N”, “G”, and “H2”, respectively. The exterior bus bars 252 are grouped into a continuous middle group, and two side groups. Only one side group is labeled in FIG. 5 to avoid obscuring the multi-conductor cable 500. Each side group has electrically independent hot and alternative hot exterior bus bars 252.

A plurality of insulation displacement connectors (IDCs) 254 are positioned on each exterior bus bar 252 with each of the groups. The IDCs 254 are preferably knife blade type connectors that provide a gas tight electrical connection with insulated wires 505, 510, 515, and 520 which are press fitted into the IDC connectors 254. The IDC connectors 254 are preferably configured to accept wires having a wire gauge from 14 to 10, and each IDC 254 is preferably capable of carrying 15 A. As seen in FIG. 5, the IDCs 254 are provided in sets of three to provide redundancy in the event that one of the knife blades does not make a proper connection with a wire. This allows a single IDC 254 in any group of three to fail while the other two IDCs in the group can still carry 30 A between them. Sets of IDCs 254 on an exterior bus bar 252 of a particular conductivity type are staggered with respect to IDCs 254 of an adjacent exterior bus bar 252 of a different conductivity type in order to minimize the possibility of shorting between exterior bus bars. As also seen in FIG. 5, these staggered sets of IDCs 254 provide a single circuit suitable for wiring a branch circuit off of the electrical box 200 as will be described. Spacers 255 are provided to prevent the safety ground from contacting the exterior bus bars 252.

High current screw holes 256 on each of the exterior bus bars 252 of each of the groups, are configured to receive a clamp type wire connector (not shown). The clamp type wire connectors clamp down on a bare conductor of wires 505, 510, 515, and 520 to provide electrical contact when a screw of the connector is fastened to the screw hole 256. These connectors are used in high current applications where IDC connectors 254 have insufficient current capacity. The high current screw holes 256 are preferably rated to carry 60 A of current and are used to hold wire clamps that can be connected to 8, 6 or 4 gauge wire which carry 40 A, 55-60 A, and 70 A capacity respectively. All bus bars 252 in the middle group of FIG. 5 preferably carry 40 A while all other bus bars in the each of the side groups are preferably rated to carry 30 A. Current from the screw holes 256 can flow in multiple directions on each bus bar 252 so that the bus bars do not have to carry as much current as the high current screw holes 256.

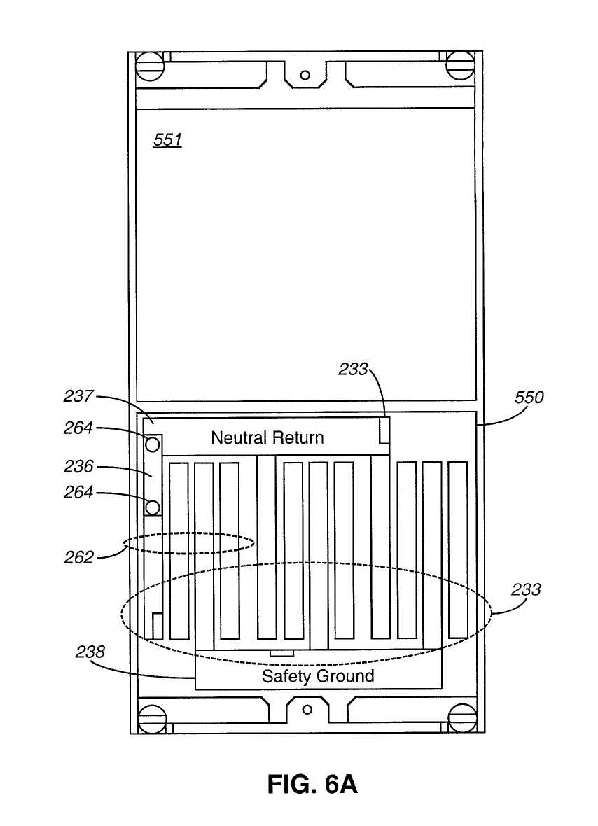

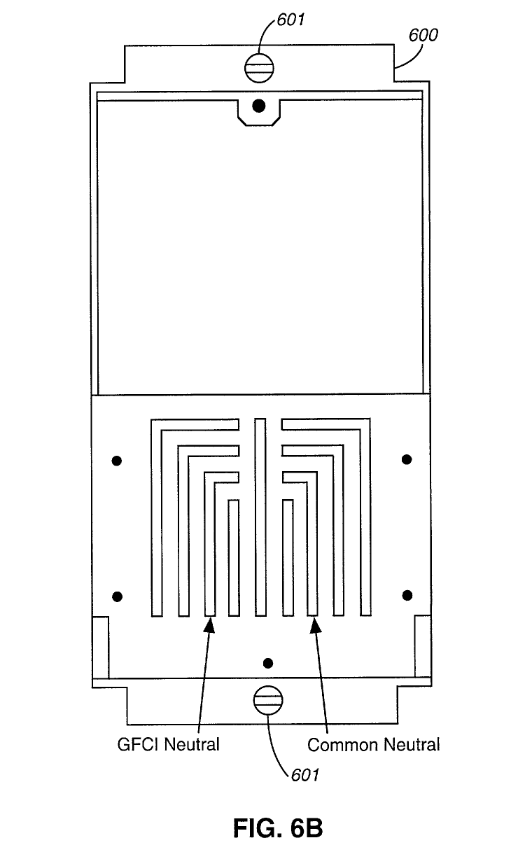

FIGS. 6A and 6B show front views of the electrical box 200 of FIG. 5 connected to multi-conductor cable 500. The electrical box 200 includes a plurality of interior bus bars 262, each of which corresponds to a hot, neutral, ground, and alternative hot are mounted on an interior surface of conductor carrier 206. Also, the middle and side groups of interior bus bars 262 correspond to the middle and side groups of exterior bus bars 252 shown in FIG. 5. While the exterior bus bars 252 of FIG. 5 and the interior bus bars 262 of FIG. 6A are shown as occupying the same area on opposing sides of the conductor board 250, it is to be understood that it is not necessary for these bus bars to occupy the same area as long as electrical connection is made between corresponding interior and exterior bus bars. Also, it is to be understood that the interior bus bars 262 and exterior bus bars 252 may be mounted on separate substrates rather than a single conductor carrier 206. Thus, corresponding elements of FIGS. 5 and 6A, such as cable 500, are positioned on opposite sides of each figure due to rotation of the electrical box 200 to obtain the back and front views of FIGS. 5 and 6A, respectively. A front view of paddle screws 248 are also shown in FIG. 6A along with screw holes 215 positioned in the tabs discussed with respect to FIG. 1.

A removable conductive tab 236 is mounted between one of the interior bus bars 262 that corresponds to neutral and a neutral bus bar 237 by use of #4 or #6 flat head screws 264. Conductive tab 236 is preferably rated for 30 A. Safety ground bus bar 238 contacts the interior bus bars 262 that are designated as ground. Neutral bus bar 237 has removable tab 236 on one of the side groups which is used with a ground fault circuit interrupter (GFCI). Tab 236 allows the neutral of a GFCI outlet to be isolated so that in the event of a ground fault it can be disconnected from the balance of the neutral.

Conductive members 233 protrude from the conductor carrier 206 of the electrical box 200 to allow mating with the electrical unit 100 as described with respect to FIG. 1. The conductive members 233 are oriented in a horizontal and vertical direction in order to allow mating of similarly oriented conductive sockets on the electrical unit 100 which have the same conductivity type. The conductive members 233 preferably carry up to 60 A for the electrical unit.

A cover plate 600, as shown in FIG. 6B, can be overlaid unto the face of FIG. 6A. The cover plate 600 is secured using two screws 601. This arrangement of the electrical box 200 permits the electrical box 200 to be plugged into a high current junction box, as well as a regular current junction box, if the GFCI neutral is attached to the common neutral in that particular box.

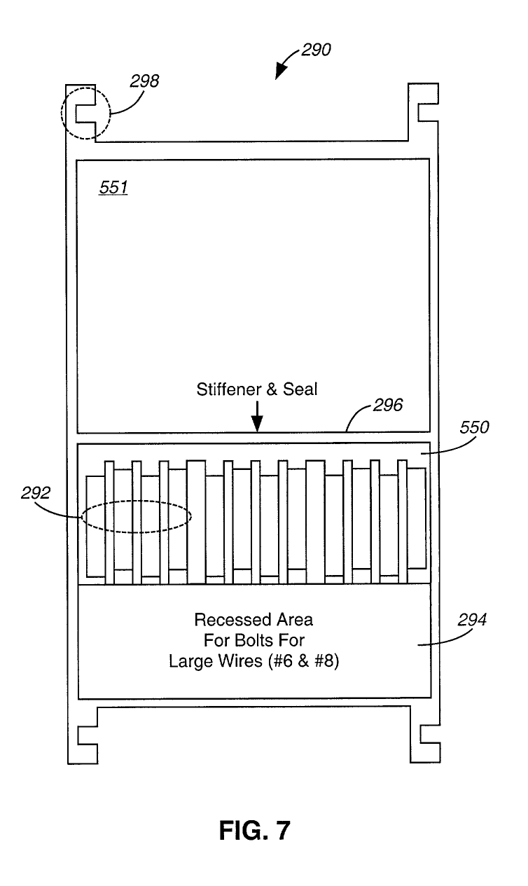

FIG. 7 shows a cover plate used to cover the IDCs 254, connected wires, and other components of the backside of the electrical box 200. Sets of push bars 292 are preferably mounted within the cover plate 290 to hold down smaller gauge wires onto the knife blades of IDCs 254. These push bars 292 are placed in different positions depending on the configuration of the electrical box 200 and may be removed if all of the wires entering the electrical box 200 are larger than 10 gauge thereby requiring high current wire clamps to be used as previously discussed. Cavity 294 provide recessed areas for large gauge wires and wire clamps, and further provide stiffening for the push bars 292. A stiffener and seal 296 separates the upper portion 551 from the lower portion 550; the lower portion 550 provides an area to house multi-compartments for low voltage signals into peripheral devices, which are plugged into electrical box 200. The cover plate 290 also includes notched tabs 298 that mate with the spacers 247 to hold the cover plate 290 onto the electrical box 200.

A functional description of the electrical unit 100 and the electrical box 200 is given below by way of an example, whereby an additional load, such as a 110 V AC electrical outlet, is added to an existing electrical circuit in a home or building. While the below description assumes that an electrician installs the new load, the present invention makes such an installation simple enough for a homeowner or other non-electrician to accomplish.

In the above-described example, the electrician first determines the location of electrical cable of an existing circuit behind a finished wall based on electrical plans or the position of existing outlets and local electrical codes if plans are not available. A wall opening is then cut in the finished wall in a desired area in close proximity to the existing cable. The wall opening is preferably cut using a template to ensure that the opening is slightly larger than the main body 203 of the electrical box 200, yet smaller than the seating lip 212. Once the wall opening is cut, insulation, vapor barrier and other debris is removed from the opening to expose the electrical cable. The exposed cable is then pulled through the wall opening as much as possible in preparation for connection to the electrical box 200.

The exposed power cable is sized against the backside of the electrical box 200 and markings are placed on the cable to designate a length of the cable that will be stripped of outer insulation sheathing. As seen in FIG. 5, the amount of insulation sheathing 525 removed is preferably of sufficient length to expose the internal wires 505, 510, 515, and 520 of the cable 500 to the IDCs 254, but short enough so that the outer sheathing of the cable 500 can be clamped within the cable clamps 245. The position at which the outer insulation sheathing 525 is stripped off the cable is indicated by the arrows in FIG. 5. As is known to one of ordinary skill in the art of electrical wiring, the insulated wires of the cable 500 are typically color coded whereby a hot wire 505 which is black, a ground wire 510 is green or a bare conductor, an alternative hot wire 515 is red, and a neutral return wire 520 is white as indicated in FIG. 5. It is to be understood that not all wires are necessary to realizing the advantages of the present application. For example, it is well known that the majority of wiring circumstances require only one hot wire in which case the cable 500 does not include the red alternative hot wire 515.

Once an optimum length of insulation is stripped from the cable 500, the cable is placed in an appropriate cable channel 230 and the cable clamp screws 246 are tightened down until the cable 500 is clamped snuggly between the cable channel 230 and the cable clamp 245. This relieves mechanical stress from electrical connections between the electrical box 200 and the wires of the cable 500 as required by the National Electric Code (NEC). Electrical connections are made by press fitting or punching down the wires 505, 510, 515, and 520 onto appropriate IDCs 254 in accordance with the color codes of the wires. In a preferred embodiment, the IDCs 254 and/or exterior bus bars 252 are color coded in coordination with the wires. Although FIG. 5 shows electrical cable 500 connected to the IDCs 254 of a side group, in adding an electrical outlet to an existing circuit, it is preferable to attach the power cable 500 to the middle group of exterior bus bars 252 as power needs to pass through the electrical box to feed downstream outlets of the existing circuit. A situation in which a cable is connected to a side group as shown in FIG. 5 will be discussed below with respect to new construction wiring.

With the insulated wires connected to the middle group of electrical box 200, back cover plate 290 is attached to the electrical box 200 to provide complete coverage of the cable clamps 245, exposed wires 505, 510, 515, and 520, and IDC connections as required by NEC. In attaching the cover plate 290, the cover plate is slid laterally into contact with the electrical box 200 such that notches 298 of the cover plate are fit snuggly around spacers 247.

With the cover plate 290 installed, the electrical box 200 is inserted into the wall opening cut to a suitable size as discussed. To insert the main body 203 of the electrical box 200 into the wall opening, fastening paddles 221 must be in a retracted position as shown by the solid lines in FIG. 1. The main body 203 is placed within the opening and the electrical box 200 is pushed into the hollow wall until the seating lip 212 is flush against the finished wall. While holding the seating lip 212 in a flush position, the paddle screws 248 are operated to rotate the fastening paddles 221 from a retracted position to a fastening position wherein the paddles protrude from the box sidewall openings 218 as shown by the phantom paddle in FIG. 1. With the paddles in a protruding position, the fastening paddles 221 abut against the interior side of the finished wall to securely fix the finished wall between the fastening paddle 221 and seating lip 212 to thereby hold the electrical box 200 in place. The distance between the protruding fastening paddle 221 and the opposing seating lip 212 is preferably ½ inch for use with ½ inch sheet rock finished wall; however, it is to be understood that this distance may be varied to accommodate a different finished wall thickness.

With the electrical box 200 fastened to the wall, the electrical unit 100 is pressed fitted into the electrical box 200 to complete the installation of a load to an existing circuit. Because the electrical box is connected to the finished wall as discussed above, and not to framing lumber, it is preferred that the mating force not be applied to the wall itself. Therefore, the electrician fastens the mating screws 111 of the electrical unit 100 with the screw holes 215 of the electrical box 200. The screws are then rotated in an alternating manner such that the electrical unit 100 is pulled into a mating position with the electrical box 200. Mating screws 111 may also be used to disconnect the electrical unit 100 from the electrical box 200. Alternately the electrical unit 100 may be mated with the electrical box 200 before the box is inserted into the wall cavity.

As best seen in FIG. 1, when the electrical box 200 is mated with the electrical unit 100, the mating edges of the electrical unit about the seating lip 212 and mating surface 214 of the electrical box 200. Electrical contact is also made between the conductive members 233 and the conductive sockets 116. A finished cover may be placed over the electrical unit 100 and seating lip 241 on the exterior of the finished wall to improve the aesthetics of the electrical unit 100 and box 200.

Thus, in adding a load to an existing circuit in a building, the electrical wires of the existing cable are quickly connected to the electrical box by punching the wires down onto the IDCs without cutting or stripping the wires. Moreover, the redundant IDCs provide a reliable gas tight electrical connection without the possibility of nicking that exists when stripping wires. Moreover, because the existing wires are not cut, it is unnecessary to provide a special junction box to provide wire extensions for the existing wires. Finally, by using the conductive member and conductive finger mating system, no wires enter the interior of the electrical box leaving more room for larger electrical units having more functions.

Improvements in new construction electrical wiring may also be realized by use of the electrical unit 100 and electrical box 200 according to the present invention. In such new construction wiring, a primary run of electrical cable is first routed from the service panel to a number of regions in the building. The electrical cable is preferably a four conductor cable rated to carry 220 V AC, 30 or higher amp, power from the service box to the different regions of the building and is routed in a continuous run without cutting the cable into segments. In routing the electrical cable through the different regions of the building, slack is preferably provided so that the cable may be pulled through a finished wall when an electrical box is attached to the electrical cable. Moreover, two or more primary 220 V AC lines may be needed for a particular building depending on the service requirement of the building and the amperage rating of the primary cable.

Once the 220 V AC 30 amp lines are routed, branch circuits are routed for each region according to a wiring plan. Each branch circuit is typically a three conductor 110V AC line that is tapped into the hot or alternative hot power of the primary 220 V AC line. As with the primary 220 V AC line, each branch circuit line is a continuous line that begins at the area where it taps into the 220 V AC line and ends at the most remote outlet location in the branch. The branch lines are not spliced into the 220V AC line, but rather are tied or taped to the 220 V AC line to maintain their position during subsequent phases of constructing the building.

The finished wall is then installed to cover the electrical wiring and any insulation installed in the wall. As there are no electrical boxes yet installed, installing the finished wall can be done more efficiently since the wall does not have to be cut around existing outlets as with prior art wiring processes. However, it is preferred that areas where the branch lines are taped or tied to the primary line be marked on the finished wall as the wall is installed.

After the wall is installed, a wall opening is cut at the marked area of the wall where the branch circuits meet the primary line and the primary line and branch lines are untied and pulled through the opening. The outer insulation is first stripped off of the primary 220V AC line which is then connected to the middle group of exterior bus bars 252 as discussed above with respect to installing a new outlet to an existing line. The ends of the branch lines are then attached to the IDCs 254 on the upper and lower portions of the side groups of the electrical box 200. As shown in FIG. 5, a continuous branch cable line may be used to route two branch circuits off of a single side group of bus bars. In this case, the hot and/or alternative hot wires are cut to isolate the upper and lower circuits as also shown in FIG. 5. Four branch circuits carrying 220V AC or preferably 110V AC may be routed from the junction box using the four sets of IDCs 254 in the upper and lower portions of each side group of the electrical box 200.

Once the primary and branch lines are connected to the IDCs 254, the back cover 290 is installed to the electrical box 200 and the electrical box is fastened to the finished wall as previously discussed. With the electronic box fixed in the wall, the electrician then installs horizontal conductive tabs 236 to the interior of the electrical box according to the number and positioning of branch circuits attached to the IDCs 254. Specifically, where the upper portion of one side group is wired to a branch circuit, a horizontal tab 236 is connected between a hot bus bar of the middle group and a corresponding hot bus bar in the upper portion of the side group to which a circuit is wired by fastening the tab to a screw hole in each bus bar using #4 or #6 flat head screws. Where a lower portion of the same side group is also wired to a branch circuit, as shown in FIG. 5, a horizontal tab 236 is also connected between a hot bus bar of the middle group and a corresponding hot bus bar in the lower portion of the side group. It is to be understood that since the middle bus bars are wired with 220 V AC power, the side circuits used for 110V AC branch circuits may be supplied power from either the hot or alternative hot bus bar of the middle group. For example, the horizontal tabs 236 of upper and lower circuits may each be fastened to the hot bus bar of the middle group, or the upper and lower bus bars of the side group may be connected to the hot and alternative hot bus bars of the middle group respectively.

Thus, in wiring a new construction building using an electrical box 200 and electrical unit 100 of the present invention, the electrical wires of the existing cable are quickly connected to the electrical box by punching the wires down onto the IDCs with minimal cutting and stripping of the wires. Moreover, the redundant IDCs provide a reliable gas tight electrical connection without the possibility of nicking that exists when stripping wires. By using the conductive member and conductive finger mating system, no wires enter the interior of the electrical box leaving more room for larger electrical units having more functions that may be planned for in a new construction home. Further, the construction of the electrical box 200 permits low voltage sources to coexist with the high voltage sources.

The present invention also provides an improved way of replacing an electrical unit that is broken or does not provide the desired electrical functions to a user. As discussed above, replacing conventional electrical units may be problematic because wires often break during removal from the unit to be replaced making it difficult or impossible to connect the wires to the new electrical unit without first extending the wires by splicing. An electrical unit according to the present invention can be replaced by simply removing the decorative cover plate and unmating the electrical unit 100 from the electrical box 200. This is preferably accomplished by unscrewing mating screws 111 from screw holes 215. The head of each screw 111 is attached to the electrical unit 100 such that unscrewing pulls the electrical unit 100 apart from the electrical box 200. A new electrical unit 100 is then aligned with the electrical box 200 such that the sockets 116 align with the conductive members 233. Screws 111 are then mated with screw holes 215 and rotated to pull the electrical unit 100 into mating contact with the electrical box 200 as described above.

Obviously, numerous modifications and variations of the present invention are possible in light of the above teachings. It is therefore to be understood that within the scope of the appended claims, the invention may be practiced otherwise than as specifically described herein. For example, while the specification discloses that electrical connection is made by a socket and finger configuration, it is to be understood that a pin and socket configuration may also be used.

What is claimed is:

1. An electrical box for receiving an electrical unit, comprising:
a low voltage section configured to provide a low voltage connection;
a barrier to isolate the low voltage connection; and
a high voltage section separated from the low voltage section via the barrier to provide a high voltage connection, the high voltage section comprising,
a plurality of bus bars, and
a plurality of displacement connectors coupled to the plurality of bus bars and configured redundantly to accept wires.

2. The electrical box of claim 1, wherein the plurality of bus bars form a plurality of groups, the bus bars associated with each of the groups correspond respectively to hot, neutral, ground, and alternative hot conductivities, the high voltage section further comprising:
a neutral member coupled to the bus bars that correspond to the neutral conductivity; and
a ground member coupled to the bus bars that correspond to the ground conductivity.

3. The electrical box of claim 2, further comprising:
a removable tab connected to the neutral member and one of the bus bars corresponding to the neutral conductivity.

4. The electrical box of claim 1, wherein the plurality of bus bars have screw holes that are configured to receive clamp type wire connectors.

5. The electrical box of claim 1, wherein the plurality of displacement connectors are knife blade type connectors.

6. The electrical box of claim 1, wherein some of the plurality of bus bars include rigid conductive fingers to provide connectivity with the electrical unit.

7. The electrical box of claim 1, further comprising:
a plurality of spacers to prevent connectivity with the ground member.

8. An apparatus for receiving an electrical unit, comprising:
a housing having a first compartment configured to provide a low voltage connection and a second compartment configured to provide a high voltage connection, the first compartment and the second compartment being electrically isolated, the second compartment comprising,
a plurality of bus bars, and
a plurality of displacement connectors coupled to the plurality of bus bars and configured redundantly to accept wires; and
a cover plate attached to a backside of the housing to hold wires into the plurality of displacement connectors.

9. The apparatus of claim 8, wherein the plurality of bus bars form a plurality of groups, the bus bars associated with each of the groups correspond respectively to hot, neutral, ground, and alternative hot conductivities, the second compartment further comprising:
a neutral member coupled to the bus bars that correspond to the neutral conductivity; and
a ground member coupled to the bus bars that correspond to the ground conductivity.

10. The apparatus of claim 9, further comprising:
a removable tab connected to the neutral member and one of the bus bars corresponding to the neutral conductivity.

11. The apparatus of claim 8, wherein the plurality of bus bars have screw holes that are configured to receive clamp type wire connectors.

12. The apparatus of claim 8, wherein the plurality of displacement connectors are knife blade type connectors.

13. The apparatus of claim 8, wherein some of the plurality of bus bars include rigid conductive fingers to provide connectivity with the electrical unit.

14. The apparatus of claim 8, wherein the cover plate includes a plurality of push bars to secure the wires onto the plurality of displacement connectors.

15. The apparatus of claim 8, wherein the cover plate includes a plurality of push bars to secure the wires onto the plurality of displacement connectors.

16. The apparatus of claim 8, further comprising:
a plurality of spacers to prevent connectivity with the ground member.

17. An electrical box for receiving an electrical unit, comprising:
means for housing a low voltage connection;
means for isolating the low voltage connection;
means for housing a high voltage connection separated from the means for housing the low voltage connection via the isolation means; and
means for electrically connecting wires within the means for housing the high voltage connection.

18. The electrical box of claim 17, wherein the means for electrically connecting the wires comprises:
a plurality of bus bars, and
a plurality of displacement connectors coupled to the plurality of bus bars and configured redundantly to accept the wires.

19. The electrical box of claim 18, wherein the plurality of bus bars form a plurality of groups, the bus bars associated with each of the groups correspond respectively to hot, neutral, ground, and alternative hot conductivities, the electrical box further comprising:
a neutral member coupled to the bus bars that correspond to the neutral conductivity; and
a ground member coupled to the bus bars that correspond to the ground conductivity.

20. The electrical box of claim 19, further comprising:
means for removably connecting the neutral member and one of the bus bars corresponding to the neutral conductivity.

21. The electrical box of claim 19, further comprising:
means for prevent connectivity with the ground member.

22. The electrical box of claim 18, wherein the plurality of bus bars have screw holes that are configured to receive clamp type wire connectors.

23. The electrical box of claim 18, wherein the plurality of displacement connectors are knife blade type connectors.

24. The electrical box of claim 18, wherein some of the plurality of bus bars include rigid conductive fingers to provide connectivity with an electrical unit.
